(19) United States
(12) Patent Application Publication
(10) Pub. No.: US 2015/0109587 A1
(43) Pub. Date: Apr. 23, 2015

(54) OPTICAL ELEMENT, LIGHTING DEVICE, AND IMAGE DISPLAY DEVICE

(71) Applicant: NEC Corporation, Tokyo (JP)

(72) Inventors: Masanao Natsumeda, Tokyo (JP); Masao Imai, Tokyo (JP); Shin Tominaga, Tokyo (JP); Naofumi Suzuki, Tokyo (JP); Mizuho Tomiyama, Tokyo (JP); Yuji Ohno, Tokyo (JP)

(21) Appl. No.: 14/403,471

(22) PCT Filed: Dec. 28, 2012
(86) PCT No.: PCT/JP2012/084047

§ 371 Date: Nov. 24, 2014

(30) Foreign Application Priority Data
May 22, 2012 (JP) 2012-117045

(51) Int. Cl. G02B 5/00; G03B 21/20

(52) U.S. Cl. CPC G02B 5/008; G03B 21/2006
USPC 353/84; 359/241

(57) ABSTRACT

Provided are an optical element, a lighting device, and an image display device, with which the absorption efficiency and the luminance of the excitation light can be improved. This optical element (40) is equipped with: a light-emitting layer (103) that generates excitation light; a plasmon excitation layer (105) stacked on the light-emitting layer (103) and having a higher plasma frequency than the light-emitting frequency of the light-emitting layer (103); an emission layer (207) that emits light by converting the surface plasmons or the light generated at the upper surface of the plasmon excitation layer (105) to light having a predetermined emission angle; and a metal layer (102) stacked on the underside of the light-emitting layer (103).

### TECHNICAL FIELD

The present invention relates to an optical element, a lighting device, and an image display device.

### BACKGROUND ART

As a light source for an image display device such as a projector, an optical element has been developed in recent years, which includes a light guide on which light (excitation light) from a light-emitting element is incident, a light-emitting layer that is provided in the light guide and in which an exciton is generated by light from the light guide, a plasmon excitation layer that is stacked on the light-emitting layer and excites a plasmon having a plasma frequency higher than frequency of light emitted when the light-emitting layer is excited by light from the light-emitting element, and an emission layer that is stacked on the plasmon excitation layer, converts light incident from the plasmon excitation layer to light having a predetermined emission angle and emits the light, for example (Patent Literature 1).

Such an optical element emits light on the following principle. First, excitation light radiated from the light-emitting element is absorbed in the light-emitting layer to generate an exciton in the light-emitting layer. The exciton combines with a free electron in the plasmon excitation layer and excites a surface plasmon. The excited surface plasmon is emitted as light.

### CITATION LIST

### Patent Literature

[PTL 1] International Publication No. WO2011/040528

### SUMMARY OF INVENTION

### Technical Problem

It is desired that light emission efficiency of the optical element described in Patent Literature 1 and the like be improved. Improvement of absorption efficiency of excitation light radiated from the light-emitting element is an important factor in improving the light emission efficiency. Additionally, it is desirable, in terms of luminance, that more excitation light be absorbed under the condition of a small angle of emission to the light-emitting layer.

An object of the present invention is to provide an optical element, a lighting device, and an image display device, with which absorption efficiency of excitation light at a small incident angle can be improved.

### Solution to Problem

To achieve the object, an optical element according to the present invention includes:

a light-emitting layer generating an exciton;

a plasmon excitation layer stacked on the upper side of the light-emitting layer and having a plasma frequency higher than a light emission frequency of the light-emitting layer;

an emission layer converting light or a surface plasmon generated on the upper surface of the plasmon excitation layer to light having a predetermined emission angle and emitting the light; and

a metal layer stacked on the underside of the light-emitting layer.

A lighting device according to the present invention includes:

the optical element of the present invention; and

a light projection unit,

wherein the lighting device is capable of projecting light by incidence of light on the light projection unit from the optical element and emission of light from the light projection unit.

An image display device according to the present invention includes:

the optical element of the present invention; and

an image display unit,

wherein the image display device is capable of displaying an image by incidence of light on the image display unit from the optical element and emission of light from the image display unit.

### Advantageous Effects of Invention

The present invention can provide an optical element, a lighting device, and an image display device, with which absorption efficiency of excitation light at a small incident angle can be improved.

### BRIEF DESCRIPTION OF DRAWINGS

FIG. 1 is a perspective view schematically illustrating a configuration of an example (a first embodiment) of an optical element according to the present invention.

FIG. 2 is a perspective view illustrating an example of a placement of light-emitting elements with respect to the example (the first embodiment) of the optical element according to the present invention.

FIG. 3A is a diagram illustrating dependence of excitation light absorptance on incident angle and polarization in an optical element including a 5-nm-thick metal layer made of Al in the first embodiment.

FIG. 3B is a diagram illustrating dependence of excitation light absorptance on incident angle and polarization in an optical element including a 5-nm-thick metal layer made of Ag in the first embodiment.

FIG. 3C is a diagram illustrating dependence of excitation light absorptance on incident angle and polarization in an optical element without a metal layer in the first embodiment.

FIG. 4A is a diagram illustrating dependence of excitation light absorptance on plasmon excitation layer thickness and metal layer thickness in an optical element including a metal layer made of Al in the first embodiment, where an angle of incidence of excitation light on the metal layer is 0 degree.

FIG. 4B is a diagram illustrating dependence of excitation light absorptance on plasmon excitation layer thickness and metal layer thickness in an optical element including a metal layer made of Ag in the first embodiment, where an angle of incidence of excitation light on the metal layer is 0 degree.

FIG. 5 is a perspective view schematically illustrating a configuration of another example (a second embodiment) of an optical element according to the present invention.

FIG. 6A is a diagram illustrating dependence of excitation light absorptance on spacer layer thickness in an optical element including a metal layer made of Al in the second embodiment, where an angle of incidence of excitation light on the metal layer is 0 degree.

FIG. 6B is a diagram illustrating dependence of metal layer thickness that provides the maximum excitation light absorptance on spacer layer thickness in an optical element including a metal layer made of Al in the second embodiment, where an angle of incidence of excitation light on the metal layer is 0 degree.

FIG. 7A is a diagram illustrating dependence of excitation light absorptance on spacer layer thickness in an optical element including a metal layer made of Ag in the second embodiment, where an angle of incidence of excitation light on the metal layer is 0 degree.

FIG. 7B is a diagram illustrating dependence of metal layer thickness that provides the maximum excitation light absorptance on spacer layer thickness in an optical element including a metal layer made of Ag in the second embodiment, where an angle of incidence of excitation light on the metal layer is 0 degree.

FIG. 8 is a perspective view schematically illustrating a configuration of yet another example (a third embodiment) of an optical element according to the present invention.

FIG. 9 is a perspective view schematically illustrating a configuration of yet another example (a fourth embodiment) of an optical element according to the present invention.

FIG. 10 is a perspective view schematically illustrating a configuration of yet another example (a fifth embodiment) of an optical element according to the present invention.

FIG. 11 is a schematic diagram illustrating a configuration of an example (a sixth embodiment) of an image display device (an LED projector) according to the present invention.

### DESCRIPTION OF EMBODIMENTS

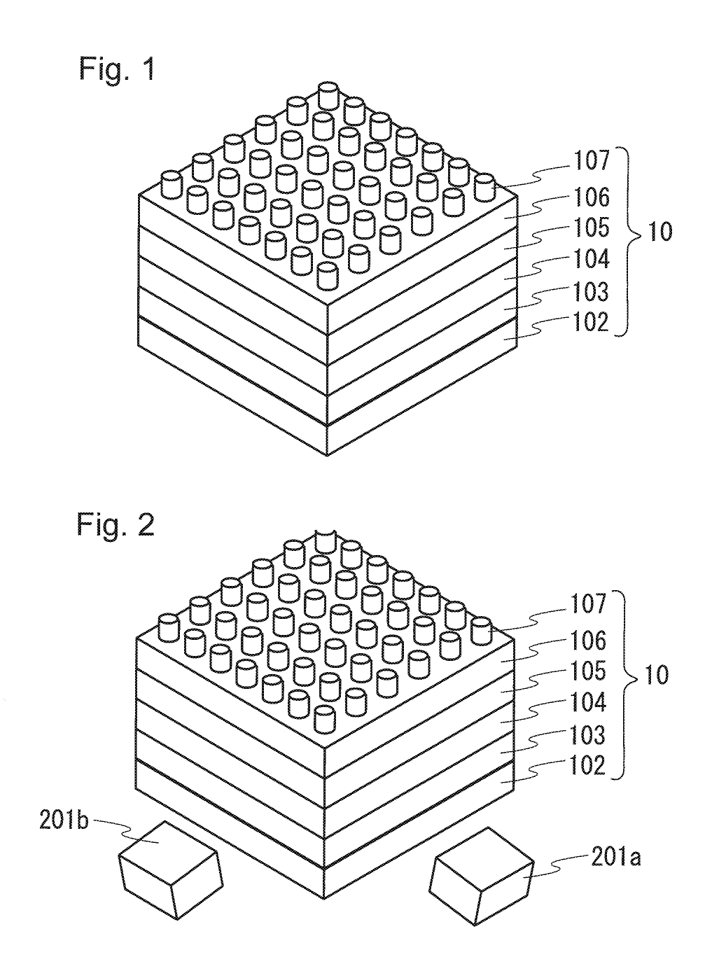

An optical element and an image display device according to the present invention will be described in detail with reference to the drawings. However, the present invention is not limited to the embodiments described below. In FIGS. 1 to 11 described below, same components are given same reference numerals and repeated description of the components may be omitted. For convenience of description, a structure of each component is appropriately illustrated in a simplified manner and each component may be schematically drawn in not to scale in the drawings. The term permittivity refers to relative permittivity unless otherwise stated.

### First Embodiment

An optical element of a first embodiment is an example of an optical element including a dielectric layer. The perspective view in FIG. 1 illustrates a configuration of the optical element of this embodiment.

As illustrated in FIG. 1, an optical element 10 of this embodiment includes a metal layer 102, a light-emitting layer 103 stacked on the metal layer 102, a dielectric layer 104 stacked on the light-emitting layer 103, a plasmon excitation layer 105 stacked on the dielectric layer 104, a dielectric layer 106 stacked on the plasmon excitation layer 105, and a wave vector transformation layer 107 stacked on the dielectric layer 106. The wave vector transformation layer 107 is the above-described “emission layer” in the optical element of the present invention.

The optical element 10 is configured so that a real part of effective permittivity of an excitation light incident section (hereinafter sometimes referred to as an “incident section”) is smaller than a real part of effective permittivity of a light emission section (hereinafter sometimes referred to as an “emission section”). The incident section includes a whole structure stacked on the plasmon excitation layer 105 on the light-emitting layer 103 side and an ambient atmosphere medium (hereinafter sometimes referred to as a “medium”) in contact with the light-emitting layer 103. The whole structure includes the dielectric layer 104 and the light-emitting layer 103. The emission section includes a whole structure stacked on the plasmon excitation layer 105 on the wave vector transformation layer 107 side and a medium in contact with the wave vector transformation layer 107. The whole structure includes the dielectric layer 106 and the wave vector transformation layer 107. Note that when a real part of effective permittivity of the incident section is smaller than a real part of effective permittivity of the emission section without the dielectric layer 104 and the dielectric layer 106, the dielectric layer 104 and the dielectric layer 106 are not necessarily essential components.

The effective permittivity is determined based on permittivity distribution of the incident section or the emission section and distribution of surface plasmons in the direction perpendicular to an interface of the plasmon excitation layer 105. The effective permittivity (∈_{eff}) can be represented by Equation (1) given below, where x axis and y axis are the directions parallel to the interface of the plasmon excitation layer 105, z axis is the direction perpendicular to the interface of the plasmon excitation layer 105 (the direction perpendicular to the mean surface when indentations are formed on the surface of the plasmon excitation layer 105), ω is an angular frequency of light emitted from the light-emitting layer 103 when the light-emitting layer 103 alone is excited with excitation light, ∈(ω, x, y, z) is a permittivity distribution of the dielectric in the incident section or the emission section for the plasmon excitation layer 105, k_{spp,z} is a z component of the wave number of surface plasmons, Im[ ] is a symbol representing an imaginary part of a number enclosed in [ ], and ∥ is a symbol representing an absolute value of a number enclosed in ∥.

$$\begin{matrix}[ Equation 1 ] & \\ {ɛ}_{eff} = {( \frac{{\int \int \int }_{D} \sqrt{ɛ ( ω , x , y , z )} exp ( - 2 \vert Im [ {k}_{spp , z} ] \vert z )}{{\int \int \int }_{D} exp ( - 2 \vert Im [ {k}_{spp , z} ] \vert z )} )}^{2} & ( 1 )\end{matrix}$$

In Equation (1), the integral range D is a range of the three-dimensional coordinates of the incident section or the emission section for the plasmon excitation layer 105. In other words, ranges in x axis and y axis directions in the integral range D is a range to the circumferential surface of the whole structure of the incident section or the circumferential surface of the whole structure of the emission section, excluding the medium, and a range to the outer edge in a plane parallel to the plane of the plasmon excitation layer 105 on the wave vector transformation layer 107 side. A range in z axis direction in the integral range D is a range of the incident section or the emission section. Note that the range in z axis direction in the integral range D is a range from the interface between the plasmon excitation layer 105 and a dielectric layer (the dielectric layer 104 or the dielectric layer 106) adjacent to the plasmon excitation layer 105 to infinity on the dielectric layer 104 side or dielectric layer 106 side of the plasmon excitation layer 105. The position of the interface is at z=0 and the direction away from the interface is (+) z direction in Equation (1). For example, when indentations are formed on the surface of the plasmon excitation layer 105, the effective permittivity can be obtained from Equation (1) by moving a z coordinate origin along the indentations on the plasmon excitation layer 105. For example, when an optically anisotropic material is contained in the range of calculation of the effective permittivity, ∈(ω, x, y, z) is a vector having different values in respective radial directions perpendicular to the z axis. In other words, there are effective permittivities of the incident section and the emission section in every radial direction perpendicular to the z axis. It is assumed in this case that values of ∈(ω, x, y, z) are the permittivities in directions parallel to radial directions perpendicular to the z axis. Accordingly, all phenomena related to effective permittivities such as k_{spp,z}, kₛₚₚ and d_{eff}, which will be described later, have different values in respective radial directions perpendicular to the z axis.

A z component k_{spp,z} of the wave number of the surface plasmons and a x and y component kₛₚₚ of the wave number of the surface plasmons can be represented by Equations (2) and (3) given below, where ∈-metal is a real part of the permittivity of the plasmon excitation layer 105 and k₀ is the wave number of light in a vacuum.

$$\begin{matrix}[ Equation 2 ] & \\ {k}_{spp , z} = \sqrt{{ɛ}_{eff} {k}_{0}^{2} - {k}_{spp}^{2}} & ( 2 ) \\ [ Equation 3 ] & \\ {k}_{spp} = {k}_{0} \sqrt{\frac{{ɛ}_{eff} {ɛ}_{metal}}{{ɛ}_{eff} + {ɛ}_{metal}}} & ( 3 )\end{matrix}$$

The effective permittivity ∈_{eff} may be calculated using an equation represented by Equation (4), Equation (5) or Equation (6) given below. However, when a material having a refractive index whose real part is less than 1 is included in the integral range, calculation diverges, and therefore Equation (1) or (4) is preferably used, and Equation (1) is especially preferably used. When a material having a refractive index whose real part is less than 1 is not included in the integral range, Equation (5) is preferably used.

$$\begin{matrix}[ Equation 4 ] & \\ {ɛ}_{eff} = \frac{{\int \int \int }_{D} ɛ ( ω , x , y , z ) exp ( - 2 \vert Im [ {k}_{spp , z} ] \vert z )}{{\int \int \int }_{D} exp ( - 2 \vert Im [ {k}_{spp , z} ] \vert z )} & ( 4 ) \\ [ Equation 5 ] & \\ {ɛ}_{eff} = {( \frac{{\int \int \int }_{D} Re [ \sqrt{ɛ ( ω , x , y , z )} ] exp ( 2 j {k}_{spp , z} z )}{{\int \int \int }_{D} exp ( j {k}_{spp , z} z )} )}^{2} & ( 5 ) \\ [ Equation 6 ] & \\ {ɛ}_{eff} = \frac{{\int \int \int }_{D} Re [ ɛ ( ω , x , y , z ) ] exp ( 2 j {k}_{spp , z} z )}{{\int \int \int }_{D} exp ( 2 j {k}_{spp , z} z )} & ( 6 )\end{matrix}$$

j is the imaginary unit and Re[ ] is a symbol representing a real part of a number enclosed in [ ]. The integral ranges and the symbols in Equations (4), (5) and (6) are the same as those in Equation (1), except that only the x and y component, kₛₚₚ, of the wave number of the surface plasmons in Equations (5) and (6) is as in Equation (7) below.

$$\begin{matrix}[ Equation 7 ] & \\ {k}_{spp} = {k}_{0} Re [ \sqrt{\frac{{ɛ}_{eff} {ɛ}_{metal}}{{ɛ}_{eff} + {ɛ}_{metal}}} ] & ( 7 )\end{matrix}$$

In the optical element 10, a distance from the surface of the plasmon excitation layer 105 on the light-emitting layer 103 side to the surface of the light-emitting layer 103 on the plasmon excitation layer 105 side is set to be shorter than an effective interaction distance d_{eff} of surface plasmons. The above-described d_{eff} can be represented by Equation (8) given below, where Im[ ] is a symbol representing an imaginary part of a number enclosed in [ ] and the effective interaction distance of surface plasmons is a distance at which intensity of the surface plasmons is e⁻²,

$$\begin{matrix}[ Equation 8 ] & \\ {d}_{eff} = \vert Im [ \frac{1}{{k}_{spp , z}} ] \vert & ( 8 )\end{matrix}$$

Therefore, the effective permittivity layer ∈_{effin} of the incident section and the effective permittivity ∈_{effout} of the emission section for the plasmon excitation layer 105 can be respectively obtained by using Equations (1), (2) and (3), and assigning the permittivity distribution ∈ᵢₙ(ω, x, y, z) on the incident section of the plasmon excitation layer 105 and the permittivity distribution ∈ₒᵤₜ(ω, x, y, z) on the emission section of the plasmon excitation layer 105, respectively, to ∈(ω, x, y, z) for calculation. For example, when permittivity anisotropy exists in a plane perpendicular to the z axis, there are effective permittivities of the incident section and the emission section in respective radial directions perpendicular to the z axis. Accordingly, all phenomena related to effective permittivities, such as k_{spp,z}, kₛₚₚ, and d_{eff,} which will be described later, have different values in respective radial directions perpendicular to the z axis as described above. In practice, the effective permittivity ∈_{eff} can be easily obtained by assigning an appropriate initial value to the effective permittivity ∈_{eff} and repeatedly calculating Equations (1), (2) and (3). Note that when a real part of permittivity of a layer in contact with the plasmon excitation layer 105 is extremely large, for example, the z component k_{spp,z} of the wave number of surface plasmons represented by Equation (2) becomes a real number. This means that a surface plasmon is not generated at the interface. Accordingly, the permittivity of the layer in contact with the plasmon excitation layer 105 is equivalent to the effective permittivity in this case. Effective permittivities in embodiments that will be described later are also defined in the same way as in Equation (1). The above description is applied to Equations (4), (5), (6) and (7) as well.

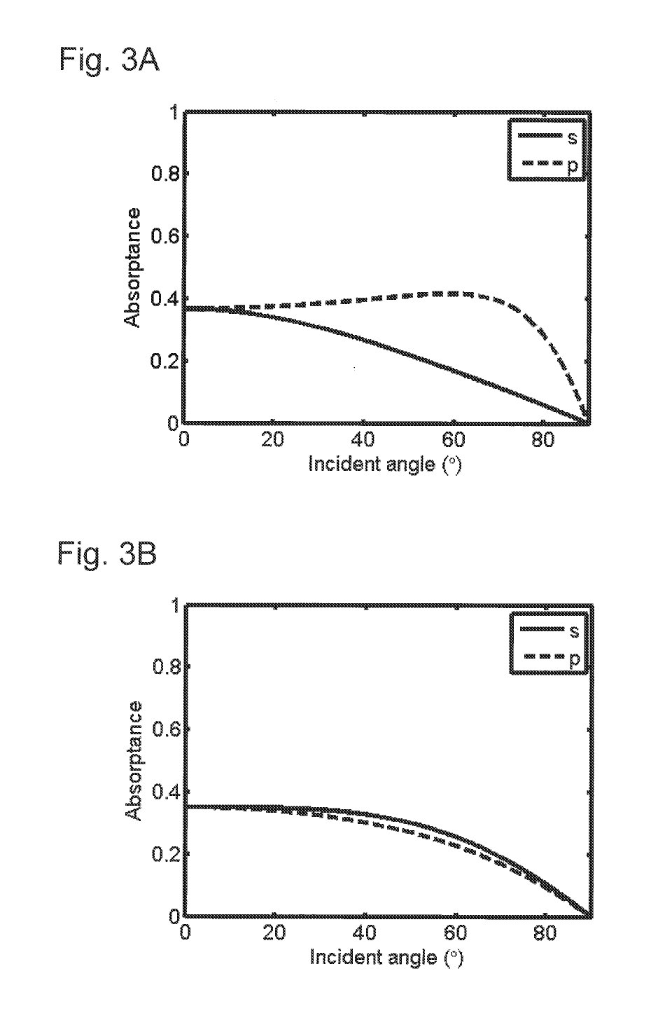

The perspective view in FIG. 2 illustrates an exemplary placement of light-emitting elements 201 with respect to an optical element of this embodiment. In the optical element 10, light emitted from light-emitting elements 201a and 201b (hereinafter sometimes referred to as “excitation light”) is incident on the light-emitting layer 103 from the metal layer 102 side. This configuration improves absorption efficiency of excitation light in the light-emitting layer 103 in the optical element 10. This advantageous effect of the optical element 10 will be described in detail below.

In order to improve efficiency of light emission of an optical element, it is important to improve absorptance of excitation light from the light-emitting element. It is also desirable in terms of luminance that more excitation light be absorbed under the condition of a small angle of emission to the light-emitting layer. The present inventors have intensely studied with the aim of improving absorption efficiency of excitation light under the condition of a small angle of emission to the light-emitting layer and then have found that disposing a metal layer on the excitation light incident side of the light-emitting layer improves absorption efficiency of excitation light under the condition of a small angle of emission to the light-emitting layer. The present inventors are the first to make this finding. Dependence of excitation light absorptance on incident angle and polarization with and without the metal layer will be further described based on the optical element 10 of this embodiment. The incident angle is an angle of incidence of excitation light on the metal layer 102. When the incident angle is small, an emission angle of excitation light to the light-emitting layer is small.

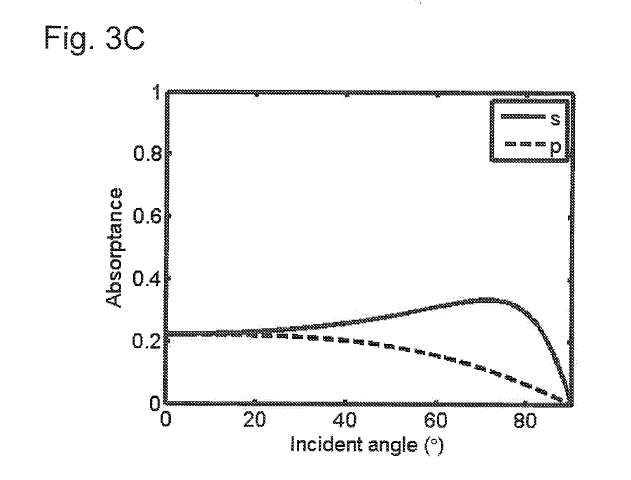

FIGS. 3A and 3B illustrate dependence of excitation light absorptance on incident angle and polarization in an optical element 10 including a 5-nm-thick metal layer 102. The metal layer 102 in the example illustrated in FIG. 3A is made of Al and the metal layer 102 in the example illustrated in FIG. 3B is made of Ag. Conditions of the optical element 10 in the examples in FIGS. 3A and 3B are set as given below. In the examples, light reflected by the optical element 10 is not reused. Light-emitting element 201: laser diode (light emission wavelength: 460 nm).

Metal layer 102: material: Al (FIG. 3A) or Ag (FIG. 3B), thickness: 5 nm.
Light-emitting layer 103: material: phosphor (refractive index: 1.7+0.02j), thickness: 40 nm.
Dielectric layer 104: material: SiO₂, thickness: 10 nm.
Plasmon excitation layer 105: material: Ag, thickness: 50 nm.
Dielectric layer 106: material: TiO₂, thickness: 0.5 mm.
Wave vector transformation layer 107: hemispherical lens (material: BK7, diameter: 10 mm).

FIG. 3C illustrates dependence of excitation light absorptance on incident angle and polarization in an optical element 10 in which the thickness of the metal layer 102 is 0 nm (in other words, no metal layer exists) as a comparative example. The other conditions for calculation are the same as those in the examples in FIGS. 3A and 3B, except absence of the metal layer 102.

In FIGS. 3A, 3B, and 3C, the horizontal axis represents the incident angle (°) of the excitation light and the vertical axis represents the absorptance of the excitation light. The legends indicate polarization state of the excitation light; “s” represents s polarization and “p” represents p polarization.

As illustrated in FIGS. 3A, 3B, and 3C, addition of the metal layer 102 improves absorptance when the incident angle of excitation light is small. The excitation light absorptance at an excitation light incident angle of 0° is 37% with the metal layer 102 of Al, 35% with the metal layer 102 of Ag, and 22% without the metal layer 102. In other words, improvement of excitation light absorptance by the metal layer 102 is 1.7 times with the metal layer 102 of Al and 1.6 times with the metal layer 102 of Ag. It can be seen that the absorptance is improved by insertion of the metal layer 102.

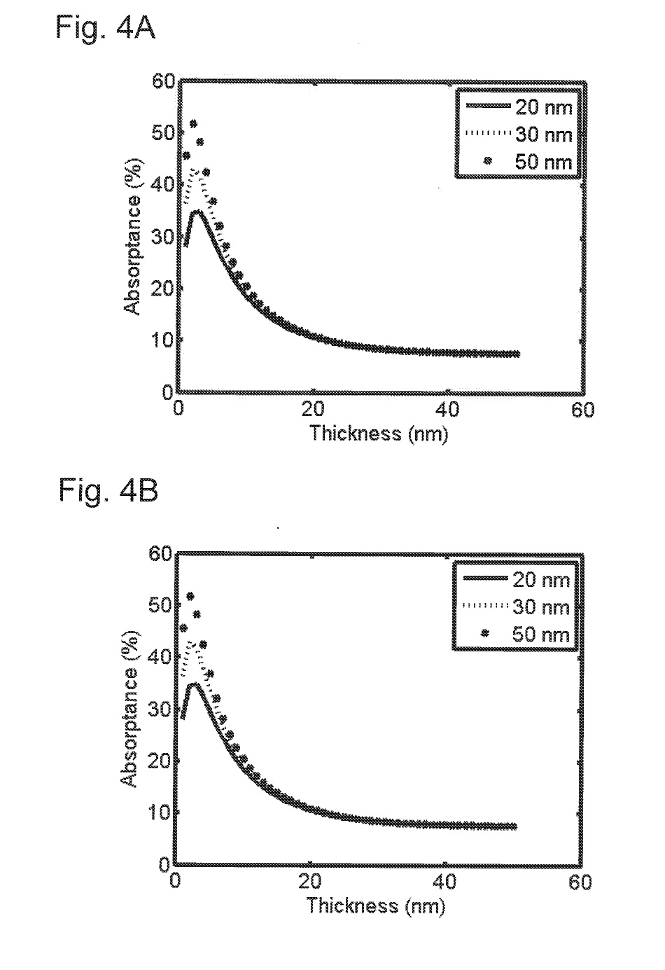

FIGS. 4A and 4B illustrate dependence of excitation light absorptance on plasmon excitation layer thickness and metal layer thickness in an optical element in which an angle of incidence of excitation light on the metal layer is 0 degree. The metal layer 102 in the example illustrated in FIG. 4A is made of Al and the metal layer 102 in the example illustrated in FIG. 4B is made of Ag. In the examples illustrated in FIGS. 4A and 4B, conditions of the optical element 10 are set as given below.

In the examples, light reflected by the optical element 10 is not reused.
Light-emitting element 201: laser diode (light emission wavelength: 460 nm).
Metal layer 102: material: Al (FIG. 4A) or Ag (FIG. 4B), thickness: 1 to 50 nm.
Light-emitting layer 103: material: phosphor (refractive index: 1.7+0.02j), thickness: 40 nm.
Dielectric layer 104: material: SiO₂, thickness: 10 nm.
Plasmon excitation layer 105: material: Ag, thickness 20 to 50 nm.
Dielectric layer 106: material: TiO₂, thickness: 0.5 mm.
Wave vector transformation layer 107: hemispherical lens (material: BK7, diameter: 10 mm).

In FIGS. 4A and 4B, the horizontal axis represents the thickness (in nm) of the metal layer 102 and the vertical axis represents the absorptance (in %) of excitation light. The legends indicate the thicknesses of the plasmon excitation layer 105.

As illustrated in FIGS. 4A and 4B, the thicker the plasmon excitation layer 105 is, the higher the excitation light absorptance is. There is an optimal value for the thickness of the metal layer 102, which is less than or equal to 25 nm in both examples.

As has been described above, the absorption efficiency of excitation light in the light-emitting layer is improved by insertion of the metal layer 102. Based on the observation, the present inventers have found that the absorption efficiency of excitation light under the condition of a small angle of emission to the light-emitting layer is improved by inserting the metal layer 102 and have completed the present invention. According to the present invention, because of improvement of the absorption efficiency of excitation light under the condition of a small angle of emission to the light-emitting layer, an optical element that radiates high luminance light, for example, can be implemented. For example, since the maximum value of the absorptance of excitation light that is incident at an incident angle of 0 degree is achieved with the metal layer 102 having thickness of less than or equal to 25 nm, the metal layer 102 is preferably in the range of 25 nm or less thick, more preferably 15 nm or less thick. Lower limit of the thickness of the metal layer 102 is not specifically limited but is greater than 0.

The metal layer 102 is preferably made of material having a high reflectance and a low absorptance for the wavelength of excitation light. Examples of material of the metal layer include [1] to [4] given below.

### [1] Al, Ag, Au, Pt, or Cu.

[2] Alloy composed primarily of at least one of Al, Ag, Au, Pt, and Cu.
[3] Dielectric composed primarily of metal in [1] or alloy in [2].
[4] A compound material containing two or more of the respective metal, alloy, and dielectric in [1] to [3].

When the wavelength of excitation light is less than 550 nm, the metal layer 102 is preferably made of any of [5] to [8] given below, but not limited thereto.

### [5] Al, Ag, or Pt.

[6] Alloy composed primarily of at least one of Al, Ag, and Pt.
[7] Dielectric composed primarily of metal in [5] or alloy in [6].
[8] A compound material containing two or more of the respective metal, alloy, and dielectric in [5] to [7].

When the wavelength of excitation light is greater than or equal to 550 nm, examples of constituent material of the metal layer 102 include [1] to [4] given above.

Next, an operation in the optical element 10 will be described in which excitation light emitted from the light-emitting element 201 is incident on the optical element 10, converted to directionally controlled light by the optical element 10, and then emitted from the wave vector transformation layer 107.

Excitation light emitted from the light-emitting element 201 passes through the metal layer 102 and is emitted to the light-emitting layer 103. Since the metal layer 102, the light-emitting layer 103, the dielectric layer 104, and the plasmon excitation layer 105 act as a light confinement structure during this process, an amount of excitation light absorbed in the light-emitting layer 103 increases. Furthermore, light reflected by the metal layer 102 and light that passes through the metal layer 102, is reflected by the plasmon excitation layer 105, and passes through the metal layer 102, interfere with each other to minimize reflection of excitation light by the metal layer 102. As a result, efficiency of coupling of excitation light into the light confinement structure made up of the metal layer 102, the light-emitting layer 103, the dielectric layer 104, and the plasmon excitation layer 105, is further improved to further increase the amount of excitation light absorbed in the light-emitting layer 103. The excitation light excites the light-emitting layer 103 to generate an exciton in the light-emitting layer 103. The exciton combines with a free electron in the plasmon excitation layer 105 across the dielectric layer 104 and excites a surface plasmon at the interface between the dielectric layer 104 and the plasmon excitation layer 105. The excited surface plasmon is emitted as light from the interface between the plasmon excitation layer 105 and the dielectric layer 106 (hereinafter sometimes referred to as “emission light”). The emission of light occurs because a real part of the effective permittivity of the incident section is smaller than a real part of the effective permittivity of the emission section. A wavelength of the emission light is equal to a wavelength of light emitted when the light-emitting layer 103 alone is excited. An emission angle θₒᵤₜ of the emission light can be represented by Equation (9) given below, where nₒᵤₜ is a refractive index of the dielectric layer 106.

$$\begin{matrix}[ Equation 9 ] & \\ {θ}_{out} = {sin}^{- 1} ( \frac{{k}_{spp}}{{n}_{out} {k}_{0}} ) & ( 9 )\end{matrix}$$

A wave number of the excited surface plasmons exists only near a range uniquely determined by Equation (2) given previously. The emission light results from only transformation of a wave vector of the surface plasmons. Accordingly an emission angle of the emission light is uniquely determined and polarization state of the emission light is always p polarized light. In other words, the emission light is highly directional p polarized light. The emission light is incident on the wave vector transformation layer 107, diffracted or refracted by the wave vector transformation layer 107, and extracted to the outside of the optical element 10. Part of the excitation light incident on the light-emitting layer 103, which is not coupled into the light confinement structure, is reflected by the optical element 10 (the plasmon excitation layer 105, for example). The reflected light may be reflected by a reflector such as a metal mirror, a dielectric mirror, and a prism and incident on the optical element 10 again to further improve efficiency of use of excitation light.

The light-emitting elements 201a and 201b emit light (excitation light) having a wavelength that the light-emitting layer 103 can absorb. Specifically, the light-emitting elements 201a and 201b may be light-emitting diodes (LED), laser diodes, super luminescent diodes, or the like, for example. The light-emitting elements 201a and 201b may be placed in any way with respect to the optical element 10 as long as excitation light passes through the metal layer 102 and is emitted to the light-emitting layer 103.

The light-emitting layer 103 is a layer that absorbs the excitation light to generate an exciton. The light-emitting layer includes a luminophore, for example. The light-emitting layer 103 may be made of a plurality of materials that emit light with the same light emission wavelength or different light emission wavelengths, for example. The thickness of the light-emitting layer 103 is not specifically limited; the thickness is preferably less than or equal to 1 μm, and especially preferably less than or equal to 100 nm, for example.

The light-emitting layer 103 is a layer in which the luminophore is dispersed in a light-transmissive member, for example. The luminophore may be in the form of particulates, for example. Examples of the luminophore include an organic phosphor, a nonorganic phosphor, a semiconductor phosphor, and the like. In terms of efficiencies of absorption and emission of the excitation light, the luminophore is preferably a semiconductor phosphor.

Examples of the organic phosphor include Rhodamine (Rhodamine 6G), sulforhodamine (sulforhodamine 101), and the like. Examples of the nonorganic phosphor include yttrium aluminum garnet, Y₂O₂S:Eu, La₂O₂S:Eu, BaMgAlxOy:Eu, BaMgAlxOy:Mn, (Sr,Ca,Ba)₅(PO₄)₃:Cl:Eu, and the like.

Examples of the semiconductor phosphor include a phosphor having a core/shell structure, a multicore shell structure, a structure having a surface combined with an organic compound, or the like. Specifically, examples of the semiconductor phosphor having a multicore shell structure include a semiconductor phosphor having a core/shell/shell structure in which a shell made of another material is further provided outside of the shell of the semiconductor phosphor having a core/shell structure; a semiconductor phosphor having a shell/core/shell structure in which a shell is disposed in the center, a core is provided so as to cover the shell, and a shell that is further provided so as to cover the outside of the core; and the like.

The core may be made of, for example, a semiconductor such as a group-IV semiconductor, a group IV-IV semiconductor, a group III-V compound semiconductor, a group II-VI compound semiconductor, a group I-VIII compound semiconductor, and a group IV-VI compound semiconductor. The core may be also made of, for example, a semiconductor such as an elemental semiconductor containing mixed crystals made of single element, a binary compound semiconductor made of two elements, and a mixed crystal semiconductor made of three or more elements. In terms of improving light emission efficiency, the core is preferably made of a direct transition semiconductor. The core is also preferably made of a semiconductor that emits visible light. In terms of durability, the material is preferably a group III-V compound semiconductor, in which atoms are strongly bonded together and which is therefore highly chemically stable.

In terms of ease of adjustment of a peak wavelength of the light emission spectrum of the semiconductor phosphor, the core is preferably made of a mixed crystal semiconductor. In terms of ease of manufacturing, on the other hand, the core is preferably made of a mixed crystal semiconductor of four or less elements.

Examples of the binary compound semiconductor that can form the core include InP, InN, InAs, GaAs, CdSe, CdTe, ZnSe, ZnTe, PbS, PbSe, PbTe, CuCl, and the like. Among these materials, InP and InN are preferable in terms of environmental burdens and the like. In terms of ease of manufacturing, CdSe and CdTe are preferable.

Examples of a ternary mixed crystal semiconductor that can form the core include InGaP, AlInP, InGaN, AlInN, ZnCdSe, ZnCdTe, PbSSe, PbSTe, PbSeTe, and the like. Among these materials, InGaP and InGaN are preferable in terms of manufacturing of a semiconductor phosphor that is environmentally harmonic and insusceptible to an external influence.

Examples of the material of the shell include a semiconductor such as a group IV semiconductor, a group IV-IV semiconductor, a group III-V compound semiconductor, a group II-VI compound semiconductor, a group I-VIII compound semiconductor, and a group IV-VI compound semiconductor. The shell may be made of, for example, a semiconductor such as an elemental semiconductor containing mixed crystals made of single element, a binary compound semiconductor made of two elements, and a mixed crystal semiconductor made of three or more elements. In terms of improving light emission efficiency, the shell is preferably made of a semiconductor having band gap energy higher than the material of the core.

In terms of capability of protecting the core, the shell is preferably made of a group III-V compound semiconductor, in which atoms are strongly bonded together and which is therefore highly chemically stable. In terms of ease of manufacturing, on the other hand, the shell is preferably made of a mixed crystal semiconductor of four or less elements.

Examples of the binary compound semiconductor that can form the shell include AlP, GaP, AlN, GaN, AlAs, ZnO, ZnS, ZnSe, ZnTe, MgO, MgS, MgSe, MgTe, CuCl, SiC, and the like. Among these materials, AlP, GaP, AlN, GaN, ZnO, ZnS, ZnSe, ZnTe, MgO, MgS, MgSe, MgTe, CuCl and SiC are preferable in terms of environmental burdens and the like.

Examples of the ternary mixed crystal semiconductor that can form the shell include AlGaN, GaInN, ZnOS, ZnOSe, ZnOTe, ZnSSe, ZnSTe, ZnSeTe, and the like. Among these materials, AlGaN, GaInN, ZnOS, ZnOTe, and ZnSTe are preferable in terms of manufacturing of a semiconductor phosphor that is environmentally harmonic and insusceptible to an external influence.

The organic compound combined with a surface of the semiconductor phosphor is preferably an organic compound including a linkage part between an alkyl group, which is a function part, and the core or the shell. Specifically, examples of the organic compound include an amine compound, a phosphine compound, a phosphine oxide compound, a thiol compound, a fatty acid, and the like.

Examples of the phosphine compound include tributylphosphine, trihexyl phosphine, trioctylphosphine, and the like.

Examples of the phosphine oxide compound include 1-dichloro-phosphinyl-heptane, 1-dichloro-phosphinyl-nonane, t-butylphosphonic acid, tetradecylphosphonic acid, dodecyl-dimethyl-phosphine-oxide, dioctyl-phosphine-oxide, didecyl-phosphine-oxide, tributyl-phosphine-oxide, tripentyl-phosphine-oxide, trihexyl-phosphine-oxide, trioctyl-phosphine-oxide, and the like.

Examples of the thiol compound include tributyl-sulfide, trihexyl-sulfide, trioctyl-sulfide, 1-heptylthiol, 1-octylthiol, 1-nonanethiol, 1-decanethiol, 1-undecanethiol, 1-dodecanethiol, 1-tridecanethiol, 1-tetradecanethiol, 1-pentadecanethiol, 1-hexadecanethiol, 1-octadecanethiol, dihexyl sulfide, diheptyl sulfide, dioctyl sulfide, dinonyl sulfide, and the like.

Examples of the amine compound include heptylamine, octylamine, nonylamine, decylamine, undecylamine, dodecylamine, tridecylamine, tetradecylamine, hexadecylamine, octadecylamine, oleylamine, dioctylamine, tributylamine, tripentylamine, trihexylamine, triheptylamine, torioctylamine, trinonylamine, and the like.

Examples of the fatty acid include lauric acid, myristic acid, palmitin acid, stearin acid, oleyl acid, and the like.

In an application that requires high monochromaticity of light emission, particle size uniformity of the semiconductor phosphor is preferable; in an application that requires a high color rendering index of light emission, particle size nonuniformity of the semiconductor phosphor is preferable. This is because the wavelength of light emitted from the semiconductor phosphor (light emission wavelength, the same hereinafter) depends on a particle size of the semiconductor phosphor.

The light-transmissive member is used for sealing the luminophore dispersedly arranged in the light-emitting layer 103 and is preferably a material that does not absorb excitation light incident on the light-emitting layer 103 and light emitted from the luminophore. The light-transmissive member is preferably made of a material that does not allow water, oxygen, and the like, to pass therethrough. The light-transmissive member made of such a material can prevent penetration of water, oxygen, and the like into the light-emitting layer 103 and alleviate influence of water, oxygen, and the like on the luminophore. Consequently, the durability of the luminophore can be improved. Examples of the material of the light-transmissive member include light-transmissive resin material such as silicone resin, epoxy resin, acrylic resin, fluorine resin, polycarbonate resin, polyimide resin, and urea resin; a light-transmissive nonorganic material such as aluminum oxide, silicon oxide, and yttria; and the like.

The light-emitting layer 103 may contain metal particles, for example. The metal particles interact with the excitation light to excite surface plasmons on surfaces of the metal particles and induce an enhanced electric field near the surfaces, which is nearly 100 times the electric field strength of the excitation light. The enhanced electric field can increase the number of excitons generated in the light-emitting layer 103 and can improve efficiency of use of the excitation light in the optical element 10, for example.

Examples of the metal of the metal particles include gold, silver, copper, platinum, palladium, rhodium, osmium, ruthenium, iridium, iron, tin, zinc, cobalt, nickel, chromium, titanium, tantalum, tungsten, indium, aluminum, alloy of these, and the like. Among these metals, gold, silver, copper, platinum, aluminum, or alloy composed primarily of any of these metals is preferable, and gold, silver, aluminum, or alloy composed primarily of any of these metals is especially preferable. The metal particles may have a core/shell structure in which the peripheral region and the central region are made of different metals; a combined hemisphere structure combining two hemispheres of different metals; a cluster-in-cluster structure in which different clusters gather to form particles; or the like. By using, for example, the alloy or special structures described above for the metal particles, resonance wavelength can be controlled without changing a size, a shape, or the like of the metal particles.

The metal particle may be of any shape that has a closed surface and may be rectangular parallelepiped, cubic, oval spherical, spherical, triangular pyramidal, trigonal prismatic, or the like, for example. Examples of the metal particle include a particle worked into a structure in which a metal thin film is formed by a closed surface that is less than 10 μm on a side by microfabrication such as a semiconductor lithography technique. A size of the metal particle is in the range of 1 to 100 nm, preferably in the range of 5 to 70 nm, and more preferably in the range of 10 to 50 nm, for example.

The plasmon excitation layer 105 is a fine-particle layer or a thin-film layer made of a material having a plasma frequency higher than the frequency of light emitted in the light-emitting layer 103 (hereinafter sometimes referred to as the “light emission frequency”) when the light-emitting layer 103 alone is excited by excitation light. In other words, the plasmon excitation layer 105 has a negative permittivity at the light emission frequency. A portion of an optically anisotropic dielectric layer, for example, may be disposed on the light-emitting layer 103 side of the plasmon excitation layer 105 in a range from the interface of the plasmon excitation layer 105 on the light-emitting layer 103 side to an effective interaction distance of surface plasmons represented by Equation (8) given previously. The dielectric layer is optically anisotropic in that the dielectric layer has different permittivities in different directions in a plane perpendicular to the direction in which the components of the optical element 10 are stacked, in other words, in a plane parallel to the interfaces between the layers. In other words, the dielectric layer has different permittivities in a given direction and a direction orthogonal to that direction in a plane perpendicular to the direction in which the components of the optical element 10 are stacked. Because of presence of the dielectric layer, the effective permittivity of the incident section in a given direction is different from the effective permittivity in a direction orthogonal to that direction in a plane perpendicular to the direction in which the components of the optical element 10 are stacked. By setting a real part of the effective permittivity of the incident section so high that plasmon coupling does not occur in a given direction and setting a real part of the effective permittivity of the incident section so low that plasmon coupling occurs in a direction orthogonal to that direction, the incident angle and polarization of light incident on the wave vector transformation layer 107, for example, can be further limited. Accordingly, efficiency of light extraction by the wave vector transformation layer 107 can be further improved.

In theory, when a sum of a real part of the effective permittivity in the incident section and a real part of the permittivity of the plasmon excitation layer 105 is negative or 0, an exciton generated in the light-emitting layer 103 excites a surface plasmon in the plasmon excitation layer 105. On the other hand, when the sum is positive, the exciton does not excite a surface plasmon. In other words, the effective permittivity that is so high that the plasmon coupling does not occur is such a permittivity that the sum of a real part of the permittivity of the plasmon excitation layer 105 and a real part of the effective permittivity of the incident section is positive; the effective permittivity that is so low that the plasmon coupling occurs is such a permittivity that the sum of a real part of the permittivity of the plasmon excitation layer 105 and a real part of the effective permittivity of the incident section is negative or 0. Efficiency of coupling of excitons generated in the light-emitting layer 103 with surface plasmons is a condition under which the sum of a real part of the effective permittivity of the incident section and a real part of the permittivity of the plasmon excitation layer 105 is 0. Accordingly, a condition under which the sum of a real part of the permittivity of the plasmon excitation 105 and the minimum value of a real part of the effective permittivity of the incident section is 0 is the most preferable in that directivity for an azimuth angle is enhanced. However, it is concerned that a decrease in an amount of light emission passing through the plasmon excitation layer 105 and heat generation in the plasmon excitation layer 105 may occur due to excessively high directivity for the azimuth angle, for example, under the condition described above. In practice, therefore, the azimuth angle directivity is preferably not increased too high. Specifically, high directional radiation can be provided in the azimuth angle ranges of 315 degrees to 45 degrees and 135 degrees to 225 degrees, for example, under the condition where the sum of a real part of the permittivity of the plasmon excitation layer 105 and a real part of the effective permittivity of the incident section is 0 in the direction at an azimuth angle of 45 degrees. Accordingly, both of improvement of directivity for an azimuth angle and minimization of decrease in light emission can be achieved. Examples of the material of the optically anisotropic dielectric layer include anisotropic crystals such as TiO₂, YVO₄, and Ta₂O₅, oriented organic molecules, and the like. Examples of the dielectric layer that is optically anisotropic due to the structure include an obliquely deposited dielectric film, an obliquely spattered dielectric film, and the like. The dielectric layer that is optically anisotropic due to the structure may be made of any material.

Examples of the material of the plasmon excitation layer 105 include gold, silver, copper, platinum, palladium, rhodium, osmium, ruthenium, iridium, iron, tin, zinc, cobalt, nickel, chromium, titanium, tantalum, tungsten, indium, aluminum, alloy of any of these metals, and the like. Among these materials, gold, silver, copper, platinum, aluminum and mixture with a dielectric primarily composed of any of these metals are preferable and gold, silver, aluminum, and mixture with a dielectric primarily composed of any of these metals are especially preferable. The thickness of the plasmon excitation layer 105 is not specifically limited but preferably less than or equal to 200 nm, especially preferably approximately 10 to 100 nm.

The surface of the plasmon excitation layer 105 on the light-emitting layer 103 side may be roughened, for example. The roughened surface provides scattering of the excitation light and excitation of localized plasmons at sharp projections on the roughened surface to increase excitons excited in the light-emitting layer 103. As a result, for example, efficiency of use of excitation light in the optical element 10 can be improved.

The dielectric layer 104 is a layer containing a dielectric. Specifically, the dielectric layer 104 may be a SiO₂ nanorod array film, or a thin film, a porous film, or the like of SiO₂, AlF₃, MgF₂, Na₃AlF₆, NaF, LiF, CaF₂, BaF₂, a low-permittivity plastic, or the like, for example. The thickness of the dielectric layer 104 is not specifically limited but, for example, in a range of 1 to 100 nm, preferably in a range of 5 to 50 nm.

Examples of the material of the dielectric layer 106 include a high-permittivity material such as diamond, TiO₂, CeO₂, Ta₂O₅, ZrO₂, Sb₂O₃, HfO₂, La₂O₃, NdO₃, Y₂O₃, ZnO, Nb₂O₅, and the like. The thickness of the dielectric layer 106 is not specifically limited.

The wave vector transformation layer 107 is an emission part that transforms a wave vector of light radiated from the interface between the plasmon excitation layer 105 and the dielectric layer 106 to cause the light to be emitted from the optical element 10. The wave vector transformation layer 107 has a function of causing the radiated light to be emitted from the optical element 10 in a direction substantially orthogonal to the interface between the plasmon excitation layer 105 and the dielectric layer 106.

A shape of the wave vector transformation layer 107 may be a surface-relief grating; a periodical or quasi-periodical structure exemplified by a photonic crystal; a texture structure (for example, a surface structure formed by a rough surface) having a texture size greater than the wavelength of light emitted from the optical element 10; hologram; a microlens array; and the like, for example. The quasi-periodical structure is an imperfect periodical structure in which a portion of a periodical structure is lost, for example. In terms of improvement of light extraction efficiency and directivity control, the shape is preferably a periodical or quasi-periodical structure exemplified by a photonic crystal, a microlens array, or the like. The photonic crystal preferably has a triangular lattice structure for the crystal structure. The wave vector transformation layer 107 may have a structure in which projections are provided on a flat base, for example.

As has been described previously, a distance from the surface of the plasmon excitation layer 105 on the light-emitting layer 103 side to the surface of the light-emitting layer 103 on the plasmon excitation layer 105 side is set to be shorter than the effective interaction distance d_{eff} of surface plasmons. Such a setting allows excitons generated in the light-emitting layer 103 to efficiently combine with free electrons in the plasmon excitation layer 105. As a result, for example, efficiency of light emission can be improved. A region where the combining efficiency is high is a region from a location in the light-emitting layer 103 where excitons are generated (for example, a location where phosphor exists in the light-emitting layer 103) to the surface of the plasmon excitation layer 105 on the light-emitting layer 103 side. The region is as small as approximately 200 nm, for example, in a range of 1 to 200 nm, or in a range of 10 to 100 nm. When the region is in the range of 1 to 200 nm in the optical element 10, the light-emitting layer 103 is preferably disposed in the range of 1 to 200 nm, for example, from the plasmon excitation layer. When the region is in the range of 10 to 100 nm, the light-emitting layer 103 is preferably disposed in the range of 10 to 100 nm, for example, from the plasmon excitation layer. Specifically, the thickness of the dielectric layer 104 is set to be 10 nm and the thickness of the light-emitting layer 103 is set to be 90 nm, for example. In terms of light extraction efficiency, a thinner light-emitting layer 103 is more preferable. In terms of light output rating, on the other hand, a thicker light-emitting layer 103 is more preferable. Therefore, the thickness of the light-emitting layer 103 is determined based on light extraction efficiency and light output rating required, for example. Note that since the range of the region varies depending on the permittivity of the dielectric layer disposed between the light-emitting layer and the plasmon excitation layer and the like, the thickness of the dielectric layer and the thickness of the light-emitting layer may be set appropriately, for example, depending on the range of the region under a given condition.

While the two light-emitting elements are disposed for the optical element of this embodiment illustrated in FIG. 2, the present invention is not limited to this example. The number of the light-emitting elements is not specifically limited. While the light-emitting elements for the optical element of this embodiment illustrated in FIG. 2 are disposed around the optical element 10, the present invention is not limited to this example. The placement of the light-emitting elements is not specifically limited as long as excitation light is incident on the light-emitting layer 103 from the metal layer 102 side. While light-emitting elements are not explicitly depicted in embodiments described later, restrictions concerning the number and placement of the light-emitting elements are the same as those in this embodiment.

The excitation light may be incident on the optical element 10 through a light guide, for example. The light guide may be rectangular parallelepiped or wedge-shaped, or have a structure for extracting light inside the light emission part or the light guide, for example. The structure for extracting light preferably includes a function of converting the angle of incidence of the excitation light on the light-emitting layer to an angle greater than the predetermined incident angle to increase the absorptance. The surface of the light guide excluding the light emission part is preferably treated, for example, with a reflective material, a dielectric multilayer film, or the like to prevent the excitation light from emitting from the surface.

While the plasmon excitation layer is provided between the two dielectric layers in the optical element of this embodiment, the dielectric layers are not essential to the present invention as has been described previously. For example, the plasmon excitation layer may be disposed on the light-emitting layer. Further, the dielectric layer may be stacked only on one of the surfaces of the plasmon excitation layer.

### Second Embodiment

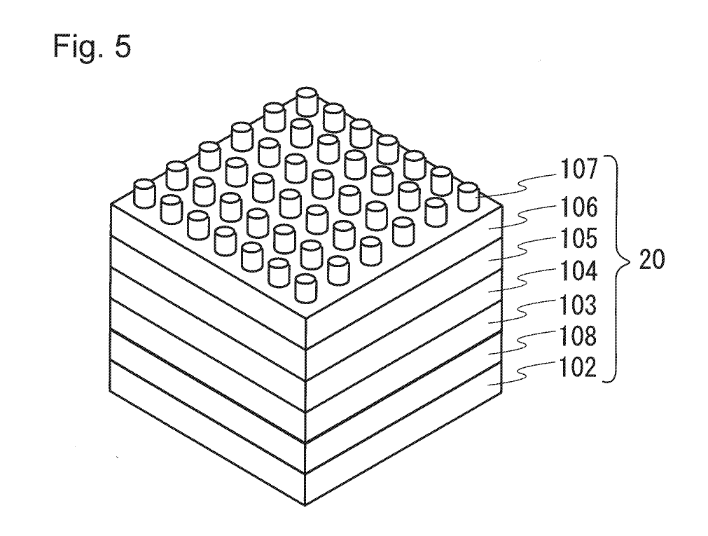

A perspective view in FIG. 5 illustrates a configuration of an optical element of a second embodiment. The configuration of the optical element of this embodiment is the same as that of the optical element of the first embodiment, except that the optical element of this embodiment includes a spacer layer between a metal layer and a light-emitting layer. As illustrated in FIG. 5, an optical element 20 of this embodiment includes a metal layer 102, a spacer layer 108 stacked on the metal layer 102, a light-emitting layer 103 stacked on the spacer layer 108, a dielectric layer 104 stacked on the light-emitting layer 103, a plasmon excitation layer 105 stacked on the dielectric layer 104, a dielectric layer 106 stacked on the plasmon excitation layer 105, and a wave vector transformation layer 107 stacked on the dielectric layer 106.

In this embodiment, the spacer layer 108 is responsible for inhibiting energy of excitons generated in the light-emitting layer 103 from being absorbed in the metal layer 102. In other words, the insertion of the spacer layer 108 improves light extraction efficiency of the optical element 20.

A ratio of energy of an exciton generated in the light-emitting layer 103 that is lost in exciting a surface plasmon or a surface wave in the metal layer 102 depends on a distance between the exciton and the surface of the metal layer 102 on the light-emitting layer 103 side. The loss exponentially increases as the distance decreases. When the thickness of the spacer layer 108 is set to be several nm or greater, excitation of the surface plasmon is dominant in the loss of energy of the exciton in the metal layer 102. In order to reduce the ratio of energy of the exciton lost in the metal layer 102, it is desirable that light intensity of the surface plasmon of the plasmon excitation layer 105 on the light-emitting layer 103 side at the exciton light emission point be higher than light intensity of the surface plasmon of the metal layer 102 on the light-emitting layer 103 side over a range in which excitons are generated, that is, the light-emitting layer 103. For example, the relation can be represented by Equation (10), where k_{spp,z, 1} is a z component of the wave number of the surface plasmon of the plasmon excitation layer 105 on the light-emitting layer 103 side, E₁ is the electric field amplitude, d₁ is a distance from the surface of the plasmon excitation layer 105 on the light-emitting layer 103 side to the exciton light emission point, k_{spp,z,2} is a z component of the wave number of the surface plasmon of the metal layer 102 on the light-emitting layer 103 side, E₂ is the electric field amplitude, and d₂ is a distance from the surface of the metal layer 102 on the light-emitting layer 103 side to the exciton light emission point. [Equation 10]

|E₁|²exp(−2|Im[k_{spp,z,1}]|d₁)>|E₂|²exp(−2|Im[k_{spp,z,2}]|d₂) (10)

k_{spp,z, 1} and k_{2pp,z,2} can be obtained by calculating effective permittivity of the plasmon excitation layer 105 on the light-emitting layer 103 side and effective permittivity of the metal layer 102 on the light-emitting layer 103 side by using the relations in Equations (1), (2) and (3). E₁ and E₂ can be obtained by an electromagnetic field calculation such as a transfer matrix calculation.

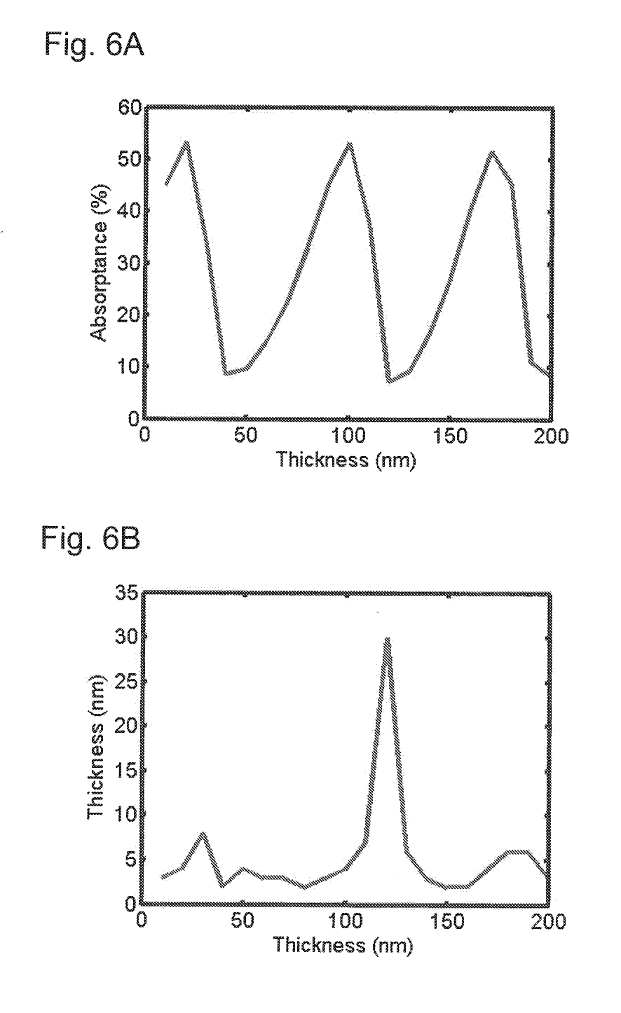

FIGS. 6A and 6B illustrate dependence of the absorptance of excitation light and the metal layer thickness on the space layer thickness in an optical element in which the metal layer is made of Al and an angle of incidence of excitation light on the metal layer is 0 degree. Conditions of the optical element 20 in the examples illustrated in FIGS. 6A and 6B are set as given below. In the examples, light reflected by the optical element 20 is not reused.

Light-emitting element 201: laser diode (light emission wavelength: 460 nm).
Metal layer 102: material: Al, thickness: 1 to 30 nm.
Spacer layer 108: material: SiO₂, thickness: 10 to 200 nm.
Light-emitting layer 103: material: phosphor (refractive index: 1.7+0.02j), thickness: 40 nm.
Dielectric layer 104: material: SiO₂, thickness: 10 nm.
Plasmon excitation layer 105: material Ag, thickness: 50 nm.
Dielectric layer 106: material: TiO₂, thickness: 0.5 mm.
Wave vector transformation layer 107: hemispherical lens (material: BK7, diameter: 10 mm).

In FIG. 6A, the horizontal axis represents the thickness (in nm) of the spacer layer 108 and the vertical axis represents the maximum absorptance (in %) of excitation light obtained when the thickness of the metal layer 102 is changed. In FIG. 6B, the horizontal axis represents the thickness (in nm) of the spacer layer 108 and the vertical axis represents the thickness (in nm) of the metal layer 102 when the maximum absorptance of excitation light is obtained.

As illustrated in FIG. 6A, the absorptance of excitation light periodically changes depending on the thickness of the spacer layer 108. As illustrated in FIG. 6B, the thickness of the metal layer 102 when the maximum absorptance of excitation light is obtained is less than or equal to 25 nm. The thickness of the metal layer 102 which can provide the maximum absorptance of excitation light exceeds 25 nm only when the thickness of the spacer layer 108 is 120 nm. However, the absorptance of excitation light at this point is minimum, and therefore excluding the thickness value from an allowable range in an application presents no problem.

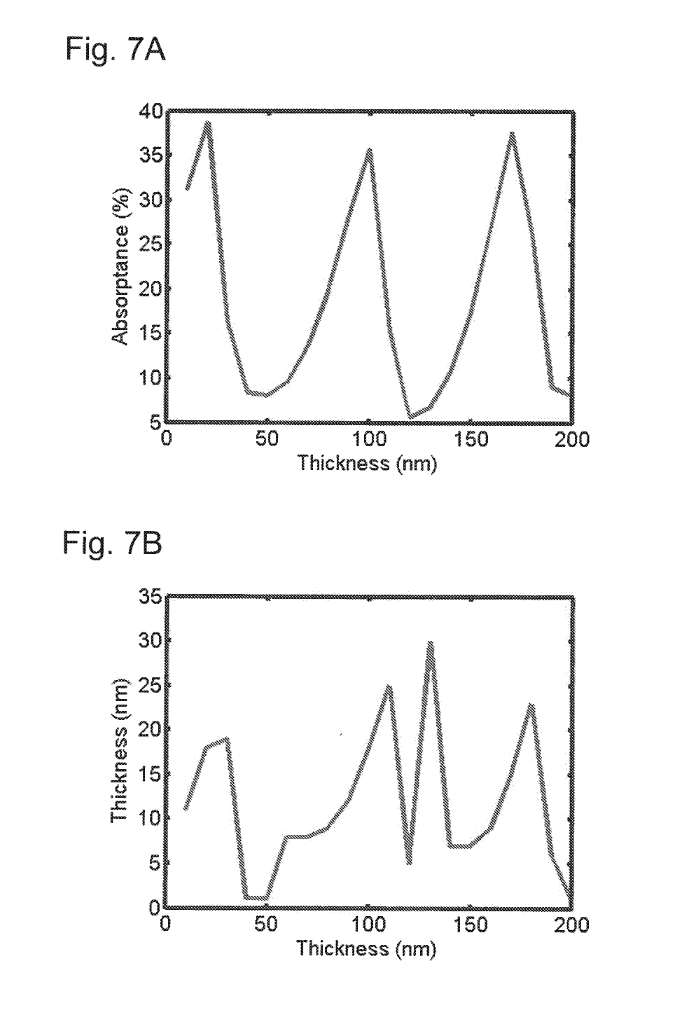

FIGS. 7A and 7B illustrate dependence of the absorptance of excitation light and the metal layer thickness on the space layer thickness in an optical element where the metal layer is made of Ag and an angle of incidence of excitation light on the metal layer is 0 degree. Conditions of the optical element 20 in the examples in FIGS. 7A and 7B are set as given below. In the examples, light reflected by the optical element 20 is not reused.

Light-emitting element 201: laser diode (light emission wavelength: 460 nm).
Metal layer 102: material: Ag, thickness: 1 to 30 nm.
Spacer layer 108: material: SiO₂, thickness: 10 to 200 nm.
Light-emitting layer 103: material: phosphor (refractive index: 1.7+0.02j), thickness: 40 nm.
Dielectric layer 104: material SiO₂, thickness: 10 nm.

Plasmon excitation layer 105: material Ag, thickness: 50 nm.

Dielectric layer 106: material TiO₂, thickness: 0.5 mm.
Wave vector transformation layer 107: hemispherical lens (material: BK7, diameter: 10 mm).

In FIG. 7A, the horizontal axis represents the thickness (in nm) of the spacer layer 108 and the vertical axis represents the maximum absorptance (in %) of excitation light obtained when the thickness of the metal layer 102 is changed. In FIG. 7B, the horizontal axis represents the thickness (in nm) of the spacer layer 108 and the vertical axis represents the thickness (in nm) of the metal layer 102 when the maximum absorption of excitation light is obtained.

As illustrated in FIG. 7A, the absorptance of excitation light periodically changes depending on the thickness of the spacer layer 108. As illustrated in FIG. 7B, the thickness of the metal layer 102 when the maximum absorptance of excitation light is obtained is less than or equal to 25 nm. The thickness of the metal layer 102 which can provide the maximum absorptance of excitation light exceeds 25 nm only when the thickness of the spacer layer 108 is 130 nm. However, the absorptance of excitation light at this point is substantially minimum, and therefore excluding the thickness value from an allowable range in an application presents no problem.

It is desirable that the refractive index and the thickness of the spacer layer 108 be adjusted so that light intensity of the surface plasmon of the plasmon excitation layer 105 on the light-emitting layer 103 side at the exciton light emission point be higher than light intensity of the surface plasmon of the metal layer 102 on the light-emitting layer 103 side over a range in which excitons are generated, that is, the light-emitting layer 103. Furthermore, it is desirable that the refractive index and the thickness of the spacer layer 108 be adjusted so that the absorptance of excitation light in the light-emitting layer 103 is maximized. In terms of light emission efficiency, the spacer layer 108 is preferably made of a material that does not absorb light at the wavelength of excitation light and the light emission wavelength of excitons. In terms of resistance to light, the space layer 108 is preferably made of a nonorganic material.

### Third Embodiment

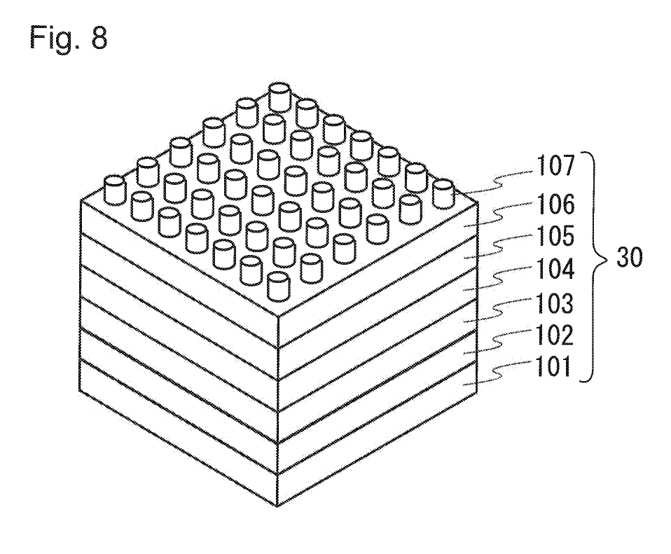

A perspective view in FIG. 8 illustrates a configuration of an optical element of a third embodiment. The optical element of this embodiment has the same configuration as the optical element of the first embodiment, except that the optical element of this embodiment includes a light guide (light guide layer) 101 on the underside of a metal layer 102. As illustrated in FIG. 8, an optical element 30 of this embodiment includes a light guide 101, a metal layer 102 stacked on the light guide 101, a light-emitting layer 103 stacked on the metal layer 102, a dielectric layer 104 stacked on the light-emitting layer 103, a plasmon excitation layer 105 stacked on the dielectric layer 104, a dielectric layer 106 stacked on the plasmon excitation layer 105, and a wave vector transformation layer 107 stacked on the dielectric layer 106.

Excitation light is incident on the metal layer 102 though the light guide 101, for example. This configuration allows light reflected by the structure from the metal layer 102 to the wave vector transformation layer 107 and incident on the light guide 101 to be incident on the metal layer 102 again. Thus, efficiency of use of excitation light in the optical element 30 can be improved. In addition, the light guide 101 has an effect of a quarter-wavelength plate, which can minimize influence of polarization dependence of the absorptance of excitation light generated in the optical element 30 in the process of reuse of excitation light.

The light guide 101 is preferably made of a material that does not absorb light at the wavelength of excitation light. Examples of such a material include a material for the light-transmissive member described previously. The light guide 101 may be rectangular parallelepiped or wedge-shaped, or have a structure for extracting light inside the light emission part or the light guide, for example. The structure for extracting light preferably includes a function of converting the angle of incidence of the excitation light on the light-emitting layer to an incident angle that is as small as possible. The surface of the light guide 101 excluding the excitation light incident part and the surface of the light guide 101 that is in contact with the metal layer 102 is preferably treated with a reflective material, a dielectric multilayer film, or the like, to prevent the excitation light from emitting from the surface, for example.

### Fourth Embodiment

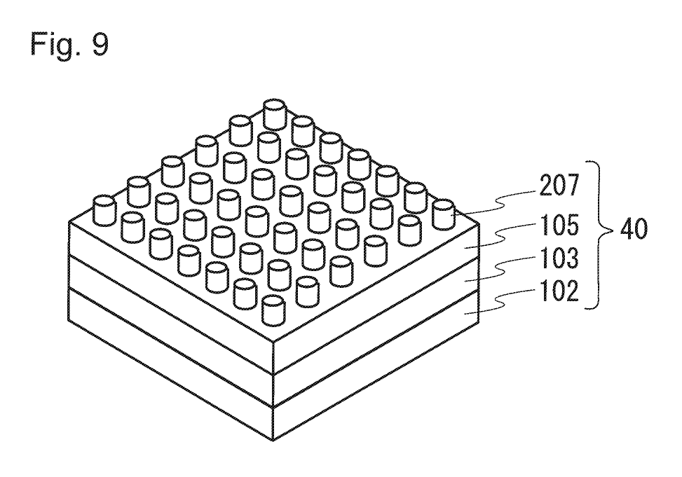

A perspective view in FIG. 9 illustrates a configuration of an optical element of a fourth embodiment. The optical element of this embodiment has the same configuration as the optical element of the first embodiment, except that the optical element of this embodiment is configured so that effective permittivity of the incident section is higher than or equal to effective permittivity of the emission section. As illustrated in FIG. 9, an optical element 40 of this embodiment includes a metal layer 102, a light-emitting layer 103 stacked on the metal layer 102, a plasmon excitation layer 105 stacked on the light-emitting layer 103, and a wave vector transformation layer 207 stacked on the plasmon excitation layer 105. The wave vector transformation layer 207 is the above-described “emission layer” in the optical element of the present invention.

The optical element 40 is configured so that the effective permittivity of the incident section is higher than or equal to the effective permittivity of the emission section. The incident section includes a whole structure stacked on the plasmon excitation layer 105 on the light-emitting layer 103 side and a medium in contact with the light-emitting layer 103. The whole structure includes the metal layer 102 and the light-emitting layer 103. The emission section includes a whole structure stacked on the plasmon excitation layer 105 on the wave vector transformation layer 207 side and a medium in contact with the wave vector transformation layer 207. The whole structure includes the wave vector transformation layer 207.

An operation in the optical element 40 will be described in which excitation light from a light-emitting element is incident on the metal layer 102 and light is emitted from the wave vector transformation layer 207.

Excitation light emitted from the light-emitting element passes through the metal layer 102 and is emitted to the light-emitting layer 103. Since the metal layer 102, the light-emitting layer 103, and the plasmon excitation layer 105 act as a light confinement structure during this process, an amount of excitation light absorbed in the light-emitting layer 103 increases. Furthermore, light reflected by the metal layer 102 and light that passes through the metal layer 102, is reflected by the plasmon excitation layer 105, and passes through the metal layer 102, interfere with each other to minimize reflection of excitation light by the metal layer 102. As a result, efficiency of coupling of excitation light into the light confinement structure made up of the metal layer 102, the light-emitting layer 103, and the plasmon excitation layer 105 is further improved to further increase an amount of excitation light absorbed in the light-emitting layer 103. Excitation light excites the light-emitting layer 103 to generate an exciton in the light-emitting layer 103. The exciton combines with a free electron in the plasmon excitation layer 105 and excites surface plasmons at the interface between the light-emitting layer 103 and the plasmon excitation layer 105 and at the interface between the plasmon excitation layer 105 and the wave vector transformation layer 207. The surface plasmons excited at the interface between the light-emitting layer 103 and the plasmon excitation layer 105 pass through the plasmon excitation layer 105 and travel to the interface between the plasmon excitation layer 105 and the wave vector transformation layer 207. The optical element 40 is configured so that the effective permittivity of the incident section is higher than or equal to the effective permittivity of the emission section, and the end of the wave vector transformation layer 207 on the plasmon excitation layer 105 side is disposed at a distance within a range of the effective interaction distance of surface plasmons from the surface of the wave vector transformation layer 207 on the plasmon excitation layer 105. When the wave vector transformation layer 207 is a flat dielectric layer, surface plasmons at the interface between the plasmon excitation layer 105 and the wave vector transformation layer 207 are not converted to light at the interface. The surface plasmons at the interface are emitted (radiated) to the outside of the optical element 40 as light because the wave vector transformation layer 207 has a function of extracting surface plasmons as light, for example, a diffraction operation. The wavelength of the emission light is equal to a wavelength of light generated when the light-emitting layer 103 alone is excited. A radiation angle θ_{rad} of the emission light can be represented by Equation (11) given below, where A is a pitch of the periodical structure of the wave vector transformation layer 207 and n_{rad} is a refractive index of the wave vector transformation layer 207 on the light extraction side (that is, the medium in contact with the wave vector transformation layer 207).

$$\begin{matrix}[ Equation 11 ] & \\ {θ}_{rad} = {sin}^{- 1} ( \frac{{k}_{spp} - i \frac{2 π}{Λ}}{{n}_{rad} {k}_{0}} ) & ( 11 )\end{matrix}$$

The wave number of surface plasmons excited at the interface between the light-emitting layer 103 and the plasmon excitation layer 105 exists only near a range uniquely determined by Equation (2) given previously. The same applies to the wave number of surface plasmons excited at the interface between the plasmon excitation layer 105 and the wave vector transformation layer 207. Accordingly, a radiation angle of the emission light is uniquely determined and the polarization state is always p polarization. In other words, the emission light is highly directional p-polarized light. Note that a part of excitation light incident on the light-emitting layer 103 that is not coupled into the waveguide is reflected by the optical element 40 (for example, the plasmon excitation layer 105). The reflected light can be reflected by a reflector such as a metal mirror, a dielectric mirror, and a prism, and incident on the optical element 40 again to improve efficiency of use of excitation light.

The wave vector transformation layer 207 is an emission part that transforms the wave vector of surface plasmons excited at the interface between the plasmon excitation layer 105 and the wave vector transformation layer 207 to extract the surface plasmons from the interface as light and allows the light to radiate from the optical element 40. In other words, the wave vector transformation layer 207 transforms the surface plasmons to light having a predetermined radiation angle and allows the light to radiate from the optical element 40. In addition, the wave vector transformation layer 207 includes a function of allowing radiation light to radiate from the optical element 40 in such a way that the radiation light is substantially orthogonal to the interface between the plasmon excitation layer 105 and the wave vector transformation layer 207, for example. The wave vector transformation layer 207 may be a wave vector transformation layer similar to the wave vector transformation layer 107 of the first embodiment, for example.

While the light-emitting layer in the optical element of this embodiment illustrated in FIG. 9 is disposed in contact with the plasmon excitation layer, the present invention is not limited to this example. A dielectric layer that has a thickness smaller than the effective interaction distance d_{eff} of surface plasmons that is represented by Equation (8) given previously may be disposed between the light-emitting layer and the plasmon excitation layer. While the wave vector transformation layer is disposed in contact with the plasmon excitation layer, the present invention is not limited to this example. For example, a dielectric layer that has a thickness smaller than the effective interaction distance d_{eff} of surface plasmons that is represented by Equation (8) may be disposed between the wave vector transformation layer and the plasmon excitation layer.

Further, in the optical element of this embodiment, an optically anisotropic dielectric layer may be disposed between the light-emitting layer and the plasmon excitation layer, as same as those in the first embodiment. In this case, for example, an angle of incidence and polarization of light incident on the wave vector transformation layer can be further limited by setting the effective permittivity of the incident section to be high enough to prevent plasmon coupling from occurring in a certain direction and to be low enough to cause plasmon coupling in a direction orthogonal to that direction. Consequently, light extraction efficiency with the wave vector transformation layer, for example, can be further improved.

The optical element of this embodiment may be configured with a spacer layer or a light guide, as same as those in the second and third embodiments described above.

### Fifth Embodiment

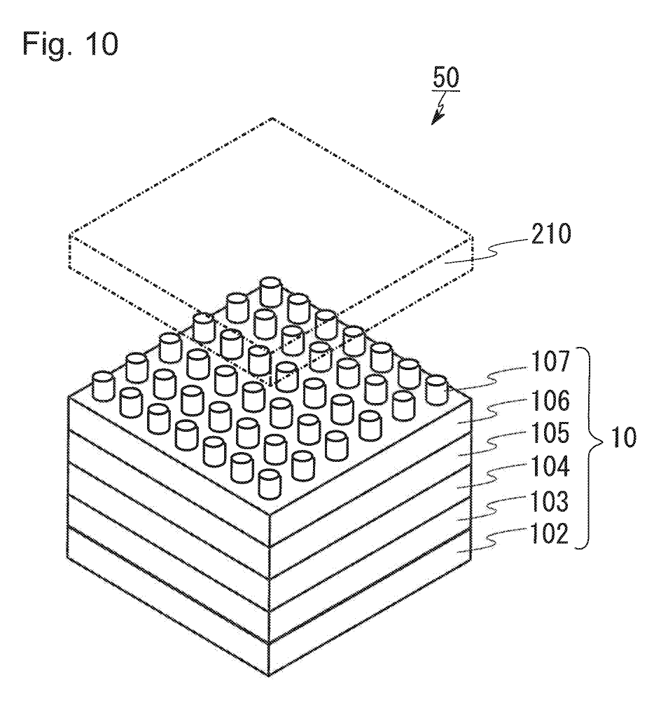

An optical element of a fifth embodiment is an example of an optical element including a half-wavelength plate as a polarization conversion element. A schematic diagram in FIG. 10 illustrates a configuration of the optical element of this embodiment.

As illustrated in FIG. 10, an optical element 50 of this embodiment includes an optical element 10 and a half-wavelength plate 210 as main components. The optical element 10 is the optical element of the first embodiment illustrated in FIG. 1. The half-wavelength plate 210 is disposed on the wave vector transformation element 107 side of the optical element 10. For convenience of description, the half-wavelength plate 210 is indicated by alternate long and short dashed lines in FIG. 10.

As described with respect to the first embodiment, light is emitted from the wave vector transformation layer 107. Since the light is P polarized as described above, the light has a field pattern with radial polarization directions. Accordingly, the light is axially symmetrically polarized light (for example, see paragraph [0104] of International Publication No. WO2011/040528). The light (axially symmetrically polarized light) is incident on the half-wavelength plate 210. The axially symmetrically polarized light is converted to linearly polarized light by the half-wavelength plate 210. In this way, the optical element of this embodiment is capable of aligning polarization state of the light (for example, see paragraph [0105] of International Publication No. WO2011/040528).

The half-wavelength plate 210 is not specifically limited and may be a well-known conventional half-wavelength plate, for example. Specifically, a half-wavelength plate disclosed in International Publication No. WO2011/040528 described below may be used, for example.

Examples of the half-wavelength plate disclosed in the International Publication include a pair of glass substrates on each of which an oriented film is formed, a liquid-crystal layer sandwiched between the glass substrates with the oriented films thereof facing each other, and a spacer disposed between the glass substrates. The liquid-crystal layer has a refractive index n₀ for ordinary light and a refractive index nₑ for extraordinary light which is greater than the refractive index nₒ. A thickness d of the liquid-crystal layer satisfies (nₑ−nₒ)×d=λ/2. λ is the wavelength of incident light in a vacuum.

Liquid-crystal molecules in the liquid-crystal layer are arranged concentrically around the center of the half-wavelength plate. The liquid-crystal molecules are oriented in a direction that satisfies one of the relations θ=2φ and θ=2φ−180, where φ is an angle between the major axis of liquid-crystal molecules and a coordinate axis near the major axis, and θ is an angle between the coordinate axis and the polarization direction.

While the half-wavelength plate in the optical element of this embodiment illustrated in FIG. 10 converts axially symmetrically polarized light to linearly polarized light, the present invention is not limited to this example. For example, the axially symmetrically polarized light may be converted to circularly polarized light. While the optical element of the first embodiment is used as the optical element of this embodiment, the present invention is not limited to this example. For example, the optical element of any of the second, third, and fourth embodiments may be used.

### Sixth Embodiment

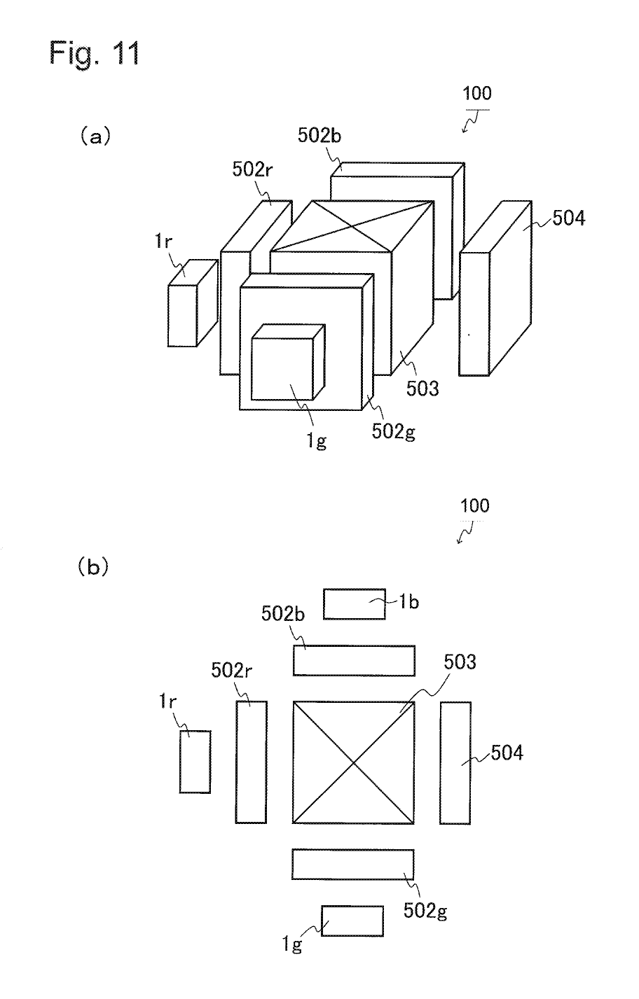

An image display device of a sixth embodiment is an example of a three-plate projection display device (LED projector). FIG. 11 illustrates a configuration of the LED projector of this embodiment. FIG. 11(a) is a schematic perspective view of the LED projector of this embodiment and FIG. 11(b) is a top view of the LED projector.

As illustrated in FIG. 11, an LED projector 100 of this embodiment includes three light source units 1r, 1g, and 1b, each of which is a combination of an optical element and a light-emitting element of any of the first to fourth embodiments described above, three liquid-crystal panels 502r, 502g, and 502b, a color mixing optical element 503, and a projection optical system 504 as main components. The pairs of the light source unit 1r and the liquid-crystal panel 502r, the light source unit 1g and the liquid-crystal panel 502g, and the light source unit 1b and the liquid-crystal panel 502b form light paths, respectively. Each of the liquid-crystal panels 502r, 502g, and 502b is the “image display unit” of the present invention.

The light source units 1r, 1g, and 1b are made of different materials for red (R) light, green (G) light and blue (B) light, respectively. The liquid-crystal panels 502r, 502g, and 502b receive light emitted from the optical elements and modulate intensity of the light depending on an image to display. The color mixing optical element 503 mixes rays of light modulated by the liquid-crystal panels 502r, 502g, and 502b. The projection optical system 504 includes a projection lens that projects emission light from the color mixing optical element 503 onto a projection surface such as a screen.

The LED projector 100 uses a control circuit (not depicted) to modulate an image on the liquid-crystal panel in each of the light paths. Provision of any of the optical elements of the first to fifth embodiments described above enables the LED projector 100 to improve luminance of a projected image. In addition, since the optical elements are extremely highly directional, the LED projector 100 does not need to use a lighting optical system, for example, and therefore reduction in size of the LED projector 100 can be achieved.

While the LED projector of this embodiment illustrated in FIG. 11 is a three-plate liquid-crystal projector, the present invention is not limited to this example. For example, the LED projector may be a single-plate liquid-crystal projector or the like. The image display device of the present invention is not limited to the LED projector. For example, the image display device may be a projector using a light-emitting element other than LED (for example, a laser diode, a super luminescent diode, or the like), or may be an image display device combined with a backlight of an liquid-crystal display device or a backlight using MEMS. Alternatively, the image display device may be a lighting device that projects light.

As has been described above, the optical elements of the present invention provide improvement on absorption efficiency and luminance of excitation light. Accordingly, an image display device that uses any of the optical elements of the present invention can be used as a projector and the like. The projector may be a mobile projector, a next-generation rear projection TV, a digital cinema, a retinal scanning display (RSD), a head up display (HUD), or an embedded projector for a mobile phone, a digital camera, a laptop personal computer, and the like and can be applied to a wide range of marketplaces. However, the optical elements are not limited to specific applications but are applicable to a wide range of fields. The optical elements are also applicable to a lighting device that projects light.

Some or all of the embodiments described above can be described as, but not limited to, the following:

### (Supplementary Note 1)

An optical element including:

a light-emitting layer generating an exciton;

a plasmon excitation layer stacked on an upper side of the light-emitting layer and having a plasma frequency higher than a light emission frequency of the light-emitting layer; and

an emission layer converting light or a surface plasmon generated on an upper surface of the plasmon excitation layer to light having a predetermined emission angle and emitting the light; and further including

a metal layer stacked on an underside of the light-emitting layer.

### (Supplementary Note 2)

The optical element according to Supplementary Note 1, further including a dielectric spacer layer between the light-emitting layer and the metal layer.

### (Supplementary Note 3)

The optical element according to Supplementary Note 1 or 2, further including a dielectric layer stacked on at least one of surfaces of the plasmon excitation layer.

### (Supplementary Note 4)

The optical element according to any one of Supplementary Notes 1 to 3,

wherein a distance between a surface of the plasmon excitation layer on the light-emitting layer side and a surface of the light-emitting layer on the plasmon excitation layer side is smaller than an effective interaction distance of a surface plasmon excited on a surface of the plasmon excitation layer on the light-emitting layer side.

### (Supplementary Note 5)

The optical element according to Supplementary Note 4, wherein the light-emitting layer is disposed at a distance in a range of 1 to 200 nm from the plasmon excitation layer.

### (Supplementary Note 6)

The optical element according to any one of Supplementary Notes 1 to 5, wherein the emission layer has a periodic surface structure.

### (Supplementary Note 7)

The optical element according to any one of Supplementary Notes 1 to 6, wherein a thickness of the metal layer is less than or equal to 25 nm.

### (Supplementary Note 8)

The optical element according to any one of Supplementary Notes 1 to 7, wherein the metal layer is made of Al, Ag, Au, Pt, Cu, alloy composed primarily of at least one of the metals, a dielectric composed primarily of any of the metals or the alloy, or a compound material including two or more materials selected from a group including the metals, the alloy, and the dielectric.

### (Supplementary Note 9)

The optical element according to any one of Supplementary Notes 1 to 8, further comprising a light guide layer on an underside of the metal layer.

### (Supplementary Note 10)

The optical element according to any one of Supplementary Notes 1 to 9, further including a polarization conversion element converting axially symmetrically polarized light emitted from the emission layer to light with a predetermined polarization state.

### (Supplementary Note 11)

The optical element according to any one of Supplementary Notes 1 to 10, wherein a real part of an effective permittivity of an incident section including a whole structure stacked on the plasmon excitation layer on the metal layer side and a medium in contact with the metal layer is smaller than a real part of an effective permittivity of an emission section including a whole structure stacked on the plasmon excitation layer on the emission layer side and a medium in contact with the emission layer.

### (Supplementary Note 12)

The optical element according to any one of Supplementary Notes 1 to 10, wherein a real part of an effective permittivity of an incident section including a whole structure stacked on the plasmon excitation layer on the metal layer side and a medium in contact with the metal layer is greater than or equal to a real part of an effective permittivity of an emission section including a whole structure stacked on the plasmon excitation layer on the emission layer side and a medium in contact with the emission layer, and an end of the emission layer on the plasmon excitation layer side is disposed at a distance in a range of an effective interaction distance of a surface plasmon from a surface of the plasmon excitation layer on the emission layer side.

### (Supplementary Note 13)

The optical element according to Supplementary Note 11 or 12, wherein the effective permittivity, ∈_{eff}, is represented by Equation (1),

$$\begin{matrix}[ Equation 1 ] & \\ {ɛ}_{eff} = {( \frac{{\int \int \int }_{D} \sqrt{ɛ ( ω , x , y , z )} exp ( - 2 \vert Im [ {k}_{spp , z} ] \vert z )}{{\int \int \int }_{D} exp ( - 2 \vert Im [ {k}_{spp , z} ] \vert z )} )}^{2} & ( 1 )\end{matrix}$$

where a x axis and a y axis are directions parallel to an interface of the plasmon excitation layer, a z axis is a direction perpendicular to an interface of the plasmon excitation layer, ω is an angular frequency of light emitted from the light-emitting layer, ∈(ω, x, y, z) is a permittivity distribution of a dielectric of the incident section or the emission section, an integral range D is a range of three-dimensional coordinates of the incident section or the emission section, k_{spp,z} is a z component of a wave number of a surface plasmon, and Im[ ] is a symbol representing an imaginary part of a number enclosed in [ ]; and a z component, k_{spp,z}, of a wave number of the surface plasmon and x and y components, kₛₚₚ, of a wave number of the surface plasmon are represented by Equations (2) and (3) given below, respectively,

$$\begin{matrix}[ Equation 2 ] & \\ {k}_{spp , z} = \sqrt{{ɛ}_{eff} {k}_{0}^{2} - {k}_{spp}^{2}} & ( 2 ) \\ [ Equation 3 ] & \\ {k}_{spp} = {k}_{0} \sqrt{\frac{{ɛ}_{eff} {ɛ}_{metal}}{{ɛ}_{eff} + {ɛ}_{metal}}} & ( 3 )\end{matrix}$$

where ∈ₘₑₜₐₗ is a real part of a permittivity of the plasmon excitation layer and k₀ is a wave number of light in a vacuum.

### (Supplementary Note 14)

The optical element according to any one of Supplementary Notes 4 to 13, wherein the effective interaction distance d_{eff} is represented by Equation (8),

$$\begin{matrix}[ Equation 8 ] & \\ {d}_{eff} = \vert Im [ \frac{1}{{k}_{spp , z}} ] \vert & ( 8 )\end{matrix}$$

where Im[ ] is a symbol representing an imaginary part of a number enclosed in [ ].

### (Supplementary Note 15)

A lighting device including:

the optical element according to any one of Supplementary Notes 1 to 14; and

a light projection unit,

wherein it is possible to project light by incidence of light on the light projection unit from the optical element and emission of light from the light projection unit.

### (Supplementary Note 16)

The lighting device according to Supplementary Note 15, further including a projection optical system projecting a projection image with light emitted from the light emission unit.

### (Supplementary Note 17)

The lighting device according to Supplementary Note 15 or 16, further including a light-emitting element,

wherein the light-emitting element forms a light source in combination with the optical element according to any one of Supplementary Notes 1 to 14;

light from the light-emitting element is incident on the light-emitting layer of the optical element to cause the light-emitting layer to generate an exciton; and

light from the light source is incident on the light emission unit.

### (Supplementary Note 18)

The lighting device according to Supplementary Note 17, including the projection optical system according to Supplementary Note 16,

wherein the light source is disposed in a direction different from a direction of emission light from the light emission unit with respect to light emission unit.

### (Supplementary Note 19)

An image display device including the optical element according to any one of Supplementary Notes 1 to 14; and

an image display unit,

wherein it is possible to display an image by incidence of light on the image display unit from the optical element and emission of light from the image display unit.

### (Supplementary Note 20)

The image display device according to Supplementary Note 19, further including a projection optical system projecting a projection image with light emitted from the image display unit.

### (Supplementary Note 21)

The image display device according to Supplementary Note 19 or 20, further including a light-emitting element,

wherein the light-emitting element forms a light source in combination with the optical element according to any one of Supplementary Notes 1 to 14;

light from the light-emitting element is incident on the light-emitting layer of the optical element to cause the light-emitting layer to generate an exciton; and

light from the light source is incident on the image display unit.

### (Supplementary Note 22)

The image display device according to Supplementary Note 21, including the projection optical system according to Supplementary Note 20,

wherein the light source is disposed in a direction different from a direction of emission light from the image display unit with respect to the image display unit.

While the present invention has been described with reference to embodiments thereof, the present invention is not limited to the above embodiments. Various modifications which are obvious to those skilled in the art can be made to configurations and details of the present invention within the scope of the present invention.

This application is based upon and claims the benefit of priority from Japanese Patent Application No. 2012-117045, filed on May 22, 2012, the disclosure of which is incorporated herein in its entirety by reference.

### REFERENCE SIGNS LIST

1, 1r, 1g, 1b Light source unit
10, 20, 30, 40, 50 Optical element
100 LED projector (image display device)
101 Light guide
102 Metal layer
103 Light-emitting layer
104 Dielectric layer
105 Plasmon excitation layer
106 Dielectric layer
107, 207 Wave vector transformation layer
108 Spacer layer
201a, 201b Light-emitting element
210 Half-wavelength plate (polarization conversion element)
502r, 502g, 502b Liquid-crystal panel
503 Color mixing optical element
504 Projection optical system

1. An optical element comprising:
a light-emitting layer generating an exciton;
a plasmon excitation layer stacked on an upper side of the light-emitting layer and having a plasma frequency higher than a light emission frequency of the light-emitting layer;
an emission layer converting light or a surface plasmon generated on an upper surface of the plasmon excitation layer to light having a predetermined emission angle and emitting the light; and
a metal layer stacked on an underside of the light-emitting layer.

2. The optical element according to claim 1, further comprising a dielectric spacer layer between the light-emitting layer and the metal layer.

3. The optical element according to claim 1, further comprising a dielectric layer stacked on at least one of surfaces of the plasmon excitation layer.

4-10. (canceled)

11. The optical element according to claim 1,
wherein a distance between a surface of the plasmon excitation layer on the light-emitting layer side and a surface of the light-emitting layer on the plasmon excitation layer side is smaller than an effective interaction distance of a surface plasmon excited on a surface of the plasmon excitation layer on the light-emitting layer side.

12. The optical element according to claim 11, wherein the light-emitting layer is disposed at a distance in a range of 1 to 200 nm from the plasmon excitation layer.

13. The optical element according to claim 1, wherein the emission layer has a periodic surface structure.

14. The optical element according to claim 1, wherein a thickness of the metal layer is less than or equal to 25 nm.

15. The optical element according to claim 1, wherein the metal layer is made of Al, Ag, Au, Pt, Cu, alloy composed primarily of at least one of the metals, a dielectric composed primarily of any of the metals or the alloy, or a compound material including two or more materials selected from a group including the metals, the alloy, and the dielectric.

16. The optical element according to claim 1, further comprising a light guide layer on an underside of the metal layer.

17. The optical element according to claim 1, further including a polarization conversion element converting axially symmetrically polarized light emitted from the emission layer to light with a predetermined polarization state.

18. The optical element according to claim 1, wherein a real part of an effective permittivity of an incident section including a whole structure stacked on the plasmon excitation layer on the metal layer side and a medium in contact with the metal layer is smaller than a real part of an effective permittivity of an emission section including a whole structure stacked on the plasmon excitation layer on the emission layer side and a medium in contact with the emission layer.

19. The optical element according to claim 1, wherein a real part of an effective permittivity of an incident section including a whole structure stacked on the plasmon excitation layer on the metal layer side and a medium in contact with the metal layer is greater than or equal to a real part of an effective permittivity of an emission section including a whole structure stacked on the plasmon excitation layer on the emission layer side and a medium in contact with the emission layer, and an end of the emission layer on the plasmon excitation layer side is disposed at a distance in a range of an effective interaction distance of a surface plasmon from a surface of the plasmon excitation layer on the emission layer side.

20. A lighting device including:
the optical element according to claim 1; and
a light projection unit,
wherein it is possible to project light by incidence of light on the light projection unit from the optical element and emission of light from the light projection unit.

21. The lighting device according to claim 20, further including a projection optical system projecting a projection image with light emitted from the light projection unit.

22. A lighting device including:
the optical element according to claim 1;
a light projection unit, and
a light-emitting element,
wherein it is possible to project light by incidence of light on the light projection unit from the optical element and emission of light from the light projection unit,
wherein the light-emitting element forms a light source in combination with the optical element according to claim 1;
light from the light-emitting element is incident on the light-emitting layer of the optical element to cause the light-emitting layer to generate an exciton; and
light from the light source is incident on the light projection unit.

23. The lighting device according to claim 22, including a projection optical system projecting a projection image with light emitted from the light projection unit,
wherein the light source is disposed in a direction different from a direction of emission light from the light projection unit with respect to light projection unit.

24. An image display device including the optical element according to claim 1; and
an image display unit,
wherein it is possible to display an image by incidence of light on the image display unit from the optical element and emission of light from the image display unit.

25. The image display device according to claim 24, further including a projection optical system projecting a projection image with light emitted from the image display unit.

26. An image display device including the optical element according to claim 1;
an image display unit, and
a light-emitting element,
wherein it is possible to display an image by incidence of light on the image display unit from the optical element and emission of light from the image display unit,
wherein the light-emitting element forms a light source in combination with the optical element according to claim 1;
light from the light-emitting element is incident on the light-emitting layer of the optical element to cause the light-emitting layer to generate an exciton; and
light from the light source is incident on the image display unit.

27. An image display device comprising:
an optical element comprising:
a light-emitting layer generating an exciton;
a plasmon excitation layer stacked on an upper side of the light-emitting layer and having a plasma frequency higher than a light emission frequency of the light-emitting layer;
an emission layer converting light or a surface plasmon generated on an upper surface of the plasmon excitation layer to light having a predetermined emission angle and emitting the light; and
a metal layer stacked on an underside of the light-emitting layer;
an image display unit, and
a light-emitting element,
wherein it is possible to display an image by incidence of light on the image display unit from the optical element and emission of light from the image display unit,
wherein the light-emitting element forms a light source in combination with the optical element;
light from the light-emitting element is incident on the light-emitting layer of the optical element to cause the light-emitting layer to generate an exciton; and
light from the light source is incident on the image display unit, including the projection optical system according to claim 25,
wherein the light source is disposed in a direction different from a direction of emission light from the image display unit with respect to the image display unit.
